(19) United States
(12) Patent Application Publication
(10) Pub. No.: US 2018/0174740 A1
(43) Pub. Date: Jun. 21, 2018

(54) SURFACE-MOUNT INDUCTOR

(71) Applicant: Murata Manufacturing Co., Ltd., Kyoto (JP)

(72) Inventor: Keita MUNEUCHI, Nagaokakyo-shi (JP)

(73) Assignee: Murata Manufacturing Co., Ltd., Kyoto (JP)

(21) Appl. No.: 15/845,143

(22) Filed: Dec. 18, 2017

(30) Foreign Application Priority Data
Dec. 21, 2016 (JP) 2016-248002

(51) Int. Cl. H01F 27/29; H01F 27/28; H01F 27/24

(52) U.S. Cl. CPC H01F 27/292; H01F 27/24; H01F 27/2828

(57) ABSTRACT

A surface-mount inductor includes a coil formed by winding a conductive wire, and a molded body made of a sealing material containing a metal magnetic material and a resin with the coil incorporated therein. The coil includes a winding part and a lead-out part with an end portion of the lead-out part disposed inside the molded body. The molded body has an external electrode disposed on a mounting surface. The surface-mount inductor includes a conductor connecting the external electrode and the lead-out part. The conductor is at least partially buried in the molded body.

### CROSS-REFERENCE TO RELATED APPLICATIONS

This application claims priority to Japanese Patent Application No. 2016-248002, filed on Dec. 21, 2016, the disclosure of which is hereby incorporated by reference in its entirety.

### TECHNICAL FIELD

The present disclosure relates to a surface-mount inductor.

### BACKGROUND

A surface-mount inductor formed by sealing a coil with a sealing material containing a magnetic powder and a resin is widely used. In the surface-mount inductor described in Japanese Laid-Open Patent Publication No. 2010-245473, both end portions of a coil are exposed on a side surface of a molded body formed of a sealing material, and external electrodes are formed on five surfaces including the side surface. In the surface-mount inductor described in Japanese Laid-Open Patent Publication No. 2013-098282, both end portions of a coil are exposed on a surface of a molded body formed of a sealing material, and external electrodes are formed in portions other than a surface opposite to a mounting surface.

### SUMMARY

The present disclosure provides a surface-mount inductor. The surface-mount inductor includes a coil formed by winding a conductive wire, and a molded body made of a sealing material containing a metal magnetic material and a resin with the coil incorporated therein. The coil includes a winding part and a lead-out part with an end portion of the lead-out part disposed inside the molded body. The molded body has an external electrode disposed on a mounting surface. The surface-mount inductor includes a conductor connecting the external electrode and the lead-out part. The conductor is at least partially buried in the molded body.

### BRIEF DESCRIPTION OF THE DRAWINGS

FIG. 1 is a transparent plane view of a surface-mount inductor of a first example viewed from the mounting surface side;

FIG. 2 is a cross-sectional view taken along a cutting-plane line A-B of FIG. 1;

FIG. 3A is a schematic for explaining a method of manufacturing the surface-mount inductor of the first example;

FIG. 3B is a schematic for explaining a method of manufacturing the surface-mount inductor of the first example;

FIG. 4 is a transparent plane view of a surface-mount inductor of a second example viewed from the mounting surface side; and

FIG. 5 is a schematic for explaining a method of manufacturing the surface-mount inductor of the second example.

### DETAILED DESCRIPTION

The surface-mount inductors described in Japanese Laid-Open Patent Publication Nos. 2010-245473 and 2013-098282 have the external electrodes formed on the surfaces other than the mounting surface and therefore are difficult to meet a requirement for further miniaturization of electronic devices using these inductors in some cases. Therefore, the present disclosure provides a surface-mount inductor having the external electrodes on the mounting surface.

A surface-mount inductor according to this embodiment includes a coil formed by winding a conductive wire, and a molded body made of a sealing material containing a metal magnetic material and a resin with the coil incorporated therein. The coil includes a winding part and a lead-out part with an end portion of the lead-out part disposed inside the molded body. The molded body has an external electrode disposed on a mounting surface. The surface-mount inductor includes a conductor connecting the external electrode and the lead-out part. The conductor is at least partially buried in the molded body. Since the external electrode disposed on the mounting surface and the lead-out part of the coil disposed in the molded body are connected by the conductor buried in the molded body, it is not necessary to dispose the external electrode on a surface other than the mounting surface. Since the end portion of the lead-out part of the coil is disposed in the molded body and is not exposed on the surface of the molded body, the shape of the lead-out part is not complicated so that the surface-mount inductor can easily be manufactured.

The conductor may entirely be buried in the molded body. Therefore, the electric conductor may be disposed in a hole formed from the mounting surface of the molded body toward the lead-out part. Thus, the conductor can be disposed without being exposed to the outside of the molded body.

The conductor may have a surface partially exposed from the molded body. Therefore, the conductor may be disposed in a groove portion formed on the mounting surface side such that the lead-out part is at least partially exposed, for example. As a result, the conductor can more easily be disposed and the productivity increases.

The lead-out part may have a connecting portion thinner than the conductive wire forming the coil, and the connecting portion may be connected to the conductor. As a result, a connection area between the lead-out part and the conductor becomes larger, and more stable connection can be achieved. The necessity to highly accurately dispose the conductor decreases and the productivity increases.

The winding axis of the coil may be orthogonal to the mounting surface. This reduces an influence of a leakage magnetic flux from the inductor on other electronic components.

Embodiments of the present disclosure will now be described with reference to the drawings. It is noted that the embodiments described below exemplify the surface-mount inductor for embodying the technical ideas of the present disclosure and that the present disclosure does not limit the surface-mount inductor to the following. The members described in claims are not limited to the members of the embodiments in any way. Particularly, dimensions, materials, shapes, relative arrangements, etc. of constituent components described in the embodiments are not intended to limit the scope of the present disclosure only thereto unless otherwise specifically described and are merely illustrative examples. In the Figures, the same portions are denoted by the same reference numerals. In consideration of facilitation of description or understanding of the main points, embodiments are separately described for convenience; however, configurations shown in different embodiments can partially be substituted or combined. In this description, the term “step” refers not only to an independent step, but also a step that cannot clearly be differentiated from other steps, as long as the intended purpose of the step is achieved.

### First Example

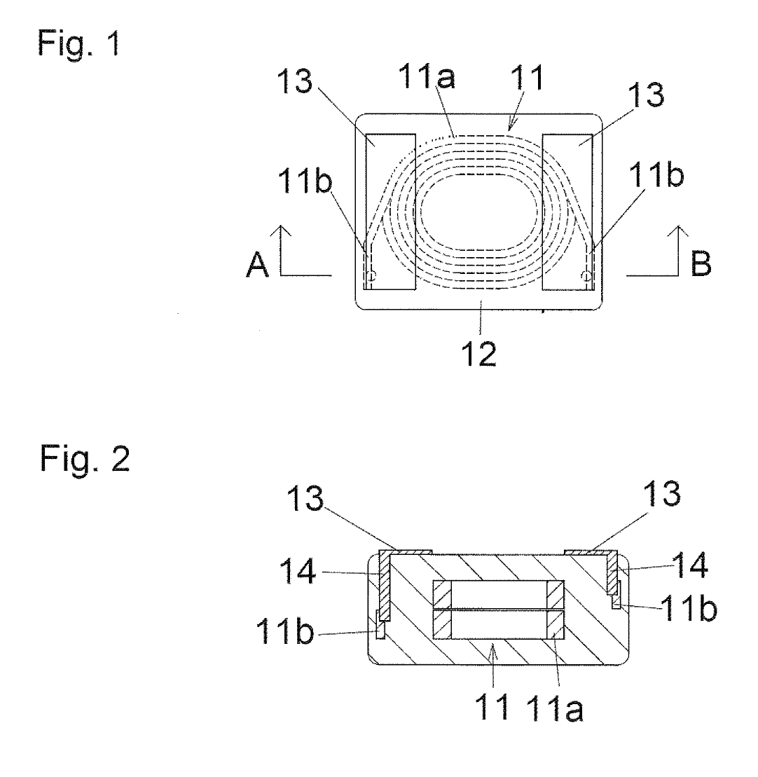

FIG. 1 is a transparent plane view of the surface-mount inductor of a first example of this embodiment viewed from the mounting surface side. In FIG. 1, a coil 11 formed by winding a conductive wire is incorporated in a molded body 12. The molded body 12 is made of a sealing material containing a metal magnetic material and a resin. The winding axis of the coil 11 incorporated in the molded body 12 is orthogonal to a mounting surface. The coil 11 has a winding part 11a formed by spirally winding, for example, a conductive wire having a rectangular cross section in outside-to-outside manner in two stages such that both end portions thereof are located on the outer circumference, and lead-out parts 11b led out from the winding part. The lead-out parts 11b are led out to positions facing each other across the winding part 11a. The end portions of the lead-out parts 11b are disposed in the molded body 12 and are not exposed on a surface of the molded body 12. External electrodes 13 are electrically connected to the lead-out parts 11 via conductors buried in the molded body 12.

In the surface-mount inductor, the two external electrodes 13 are disposed on the mounting surface, and the external electrodes 13 are not extended to surfaces adjacent to the mounting surface. The external electrodes 13 are disposed at positions on the mounting surface respectively corresponding to the two lead-out parts 11b that are both ends of the coil.

FIG. 2 is a cross-sectional view of the surface-mount inductor taken along a cutting-plane line A-B of FIG. 1. In FIG. 2, the winding part 11a of the coil 11 formed by winding the conductive wire having a rectangular cross section in two stages and the lead-out parts 11b led out from the two respective stages of the winding part 11a are incorporated in the molded body 12. The external electrodes 13 are electrically connected to the lead-out parts 11b via respective conductors 14. The conductors 14 are buried in columnar spaces formed in the molded body 12 and are not exposed to the outside of the molded body. The conductors 14 are disposed in contact with connecting portions reduced in thickness in the lead-out parts 11b. In FIG. 2, the external electrodes 13 and the conductors 14 are integrally formed. The external electrodes 13 and the conductors 14 are formed by using a material different from the conductive wire forming the coil, such as conductive paste and plating. As used herein, the “material different from the conductive wire” does not exclude that the conductive material (e.g., metal) contained in the material is the same, as long as the material has a form different from the conductive wire.

The surface-mount inductor may be manufactured by a manufacturing method including, for example, preparing a molded body made of a sealing material containing a metal magnetic material and a resin with a coil having a winding part and a lead-out part incorporated therein, forming a space portion having an opening in a mounting surface orthogonal to the winding axis of the coil and exposing at least a portion of the lead-out part of the coil, and connecting the lead-out part via a conductor disposed in the space portion to an external electrode disposed on the mounting surface.

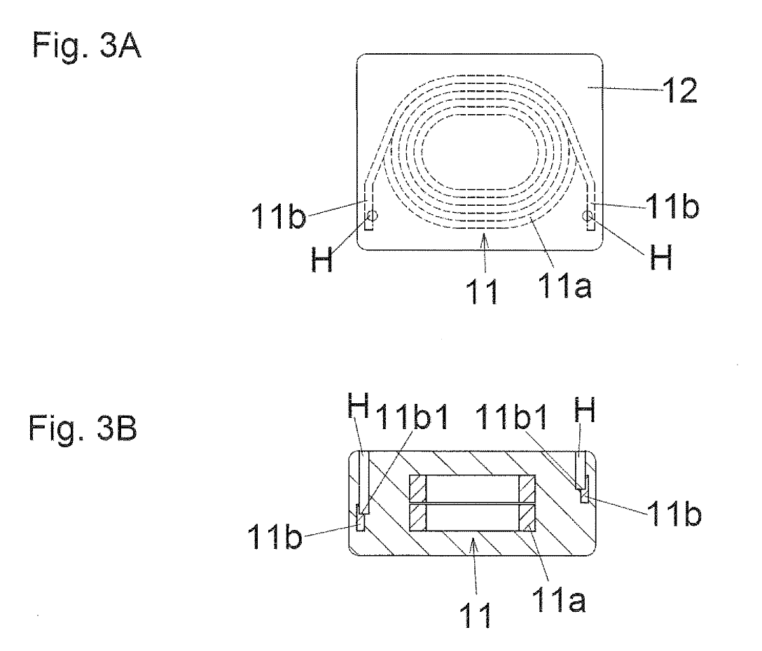

A method of manufacturing the surface-mount inductor of a first example will be described with reference to FIGS. 3A and 3B. FIG. 3A is a transparent plane view of the molded body 12 before forming the external electrodes viewed from the mounting surface side, and FIG. 3B is a cross-sectional view of the molded body 12.

First, the molded body 12 made of a sealing material containing a metal magnetic material and a resin with the coil 11 incorporated therein as shown in FIG. 3A is prepared. The coil 11 includes the winding part 11a formed by winding a conductive wire and the lead-out parts 11b disposed at both ends of the coil and led out from the winding part 11a. The winding part 11a and the lead-out parts 11b of the coil 11 are incorporated in the molded body 12. The end portions of the lead-out parts 11b of the coil 11 are disposed in the molded body 12 and are not exposed on the surface of the molded body 12. The molded body 12 is formed by pressure forming after covering the coil 11 with the sealing material containing a metal magnetic material and a resin. In FIG. 3A, two holes H having openings in the mounting surface and reaching the respective lead-out parts 11b of the coil 11 are formed orthogonally to the mounting surface. The lead-out parts 11b are partially exposed on the bottoms of the holes H and portions of side surfaces adjacent to the bottoms. The holes H are formed in the molded body 12 such that a portion of the conductive wire of the lead-out parts 11b is removed to form the connecting portions thinner than the conductive wire on the lead-out parts 11b. The side surfaces of the holes H are not exposed to the outside of the molded body 12. The holes H are formed by using a drill or a laser, for example.

FIG. 3B is a cross-sectional view taken along a cutting-plane line crossing the two holes H of FIG. 3A. In FIG. 3B, the two holes H are formed in a direction perpendicular to the mounting surface from the mounting surface toward the lead-out parts 11b. At the positions where the holes H are formed, the lead-out parts 11b have the cross sections partially cut off to form connecting portions 11b1 reduced in thickness. The length of the holes H in the direction perpendicular to the mounting surface is adjusted so as not to traverse the lead-out parts 11b depending on the position of the lead-out parts 11b.

In each of the holes H formed in the molded body 12, the conductor connecting the lead-out part 11b and the external electrode is disposed. The conductor has one end connected to the connecting portion of the lead-out part 11b and the other end exposed to the opening and arranged connectable with the external electrode. The conductor is formed of conductive paste or plating, for example. In one form, the conductor is formed integrally with the external electrode. Therefore, the conductor can be formed by applying the material forming the conductor to the hole and a portion of the mounting surface.

In FIG. 3A, the hole H has a circular cross section; however, the cross section may be oval, elliptical, polygonal, etc. Although the hole H is formed to partially cut off the lead-out part 11b, the hole H may be formed such that the side surface thereof is in contact with the lead-out part 11b. The number of the holes H formed toward each of the lead-out parts 11b is not limited to one, and a plurality of the holes H may be formed toward each of the lead-out parts. In FIG. 3B, the hole H is formed orthogonally to the mounting surface so as not to traverse the lead-out part 11b; however, in another form, the hole H may be formed to traverse the lead-out part 11b. Alternatively, the hole H may not be orthogonal to the mounting surface and may be formed to intersect with the lead-out part 11b.

### Second Example

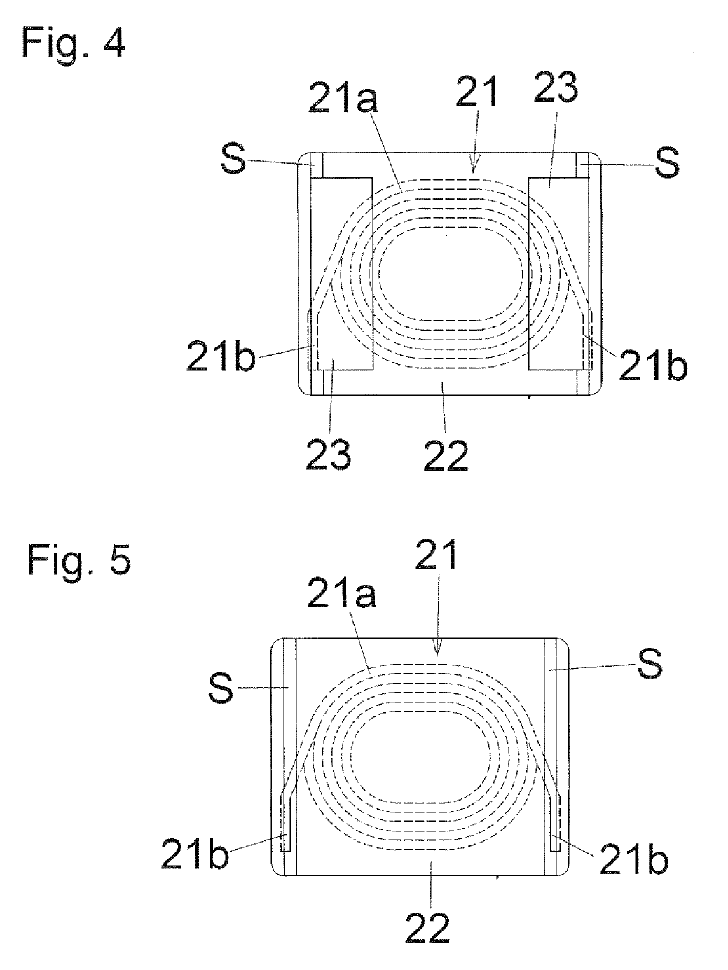

FIG. 4 is a transparent plane view of a surface-mount inductor of a second example of this embodiment viewed from the mounting surface side. The surface-mount inductor of the second example is configured in the same way as the surface-mount inductor of the first example except that the conductor connecting the lead-out part of the coil and the external electrode is not entirely buried in the molded body and is disposed in a groove provided on the mounting surface side such that the conductor is partially exposed from the molded body.

In FIG. 4, a coil 21 formed by winding a conductive wire is incorporated in a molded body 22 made of a sealing material containing a metal magnetic material and a resin. The winding axis of the coil 21 incorporated in the molded body 22 is orthogonal to a mounting surface. The coil 21 has a winding part 21a formed by spirally winding, for example, a conductive wire having a rectangular cross section in outside-to-outside manner in two stages such that both end portions thereof are located on the outer circumference, and lead-out parts 21b led out from the winding part. The lead-out parts 21b are led out to positions facing each other across the winding part 21a. The end portions of the lead-out parts 21b are disposed in the molded body 22 and are not exposed on a surface of the molded body 22. External electrodes 23 are electrically connected to the lead-out parts 21b via conductors disposed in grooves S of the molded body 22.

In the surface-mount inductor, the two external electrodes 23 are disposed on the mounting surface, and the external electrodes 23 are not extended to surfaces adjacent to the mounting surface. The external electrodes 23 are disposed at positions on the mounting surface respectively corresponding to the two lead-out parts 21b that are both ends of the coil.

The grooves S are each formed to a depth reaching the lead-out part 21b on the mounting surface side of the molded body, and the lead-out part 21b is partially exposed on the bottom of the groove S and a portion of a side surface adjacent to the bottom. The grooves S are formed in the molded body 22 such that a portion of the conductive wire of the lead-out parts 21b is removed to form connecting portions thinner than the conductive wire on the lead-out parts 21b. The grooves S are each formed such that cut-outs serving as openings are disposed in two respective surfaces adjacent to the mounting surface and opposite to each other. The conductor disposed in the groove S may be arranged to be capable of connecting the connecting portion of the lead-out part 21b and the external electrode 23 and may not be disposed in the entire groove S. In one form, the conductor is disposed directly under the external electrode 23. The conductor is formed by using conductive paste or plating, for example.

A method of manufacturing the surface-mount inductor of the second example will be described with reference to FIG. 5. FIG. 5 is a transparent plane view of the molded body 22 before forming the external electrodes viewed from the mounting surface side.

First, the molded body 22 made of a sealing material containing a metal magnetic material and a resin with the coil 21 incorporated therein as shown in FIG. 5 is prepared. The coil 21 includes the winding part 21a formed by winding a conductive wire and the lead-out parts 21b disposed at both ends of the coil and led out from the winding part 21a. The winding part 21a and the lead-out parts 21b of the coil 21 are incorporated in the molded body 22. The end portions of the lead-out parts 21b of the coil 21 are disposed in the molded body 22 and are not exposed on the surface of the molded body 22. The molded body 22 is formed by pressure forming after covering the coil 21 with the sealing material containing a metal magnetic material and a resin. In FIG. 5, the two grooves S each having openings on the mounting surface and two surfaces adjacent to the mounting surface and reaching the respective lead-out parts 21b of the coil 21 are formed in a direction orthogonal to the mounting surface. The lead-out parts 21b are partially exposed on the bottoms of the grooves S. The grooves S are formed in the molded body 22 such that a portion of the conductive wire of the lead-out parts 21b is removed to form the connecting portions thinner than the conductive wire on the lead-out parts 21b. The depth of the groove S in the direction perpendicular to the mounting surface is adjusted so as not to traverse the lead-out parts 21b depending on the position of the lead-out parts 21b. The grooves S can be formed by cutting off a portion of the molded body from the mounting surface side by using a laser or a dicer, for example.

In each of the grooves S formed on the molded body 22, the conductor connecting the lead-out part 21b and the external electrode is disposed. The conductor has a portion connected to the connecting portion of the lead-out part 11b and the other portion exposed to the opening and arranged connectable with the external electrode. The conductor is formed of conductive paste or plating, for example. In one form, the conductor is formed integrally with the external electrode. Therefore, the conductor can be formed by applying the material forming the conductor to the groove S and a portion of the mounting surface.

In FIG. 5, the grooves S are each formed to have the openings in two surfaces adjacent to the mounting surface; however, the opening may be disposed in only one of the surfaces. The bottom of the groove S may be formed into a flat surface or may be formed to have a curved surface.

In the embodiment described above, the conductive wire forming the coil is not limited to the conductive wire having a rectangular cross section, and may be a conductive wire having a circular cross section or a polygonal cross section. Although the winding part of the coil is formed into an elliptical shape, the winding part may be circular, polygonal, etc. The coil is formed by so-called a winding so that both ends thereof are located on the outer circumference; however, the winding method of the coil may be irregular winding, edgewise winding, aligned winding, etc. The external electrode may be formed separately from the conductor, and metal plating etc. may further be applied onto the external electrode formed integrally with the conductor.

It is to be understood that although the present disclosure has been described with regard to preferred embodiments thereof, various other embodiments and variants may occur to those skilled in the art, which are within the scope and spirit of the disclosure, and such other embodiments and variants are intended to be covered by the following claims.

All publications, patent applications, and technical standards mentioned in this specification are herein incorporated by reference to the same extent as if each individual publication, patent application, or technical standard was specifically and individually indicated to be incorporated by reference.

What is claimed is:

1. A surface-mount inductor comprising:
a coil, formed by winding a conductive wire, and including a winding part and a lead-out part with an end portion;
a molded body made of a sealing material containing a metal magnetic material and a resin with the coil incorporated therein, the molded body having an external electrode disposed on a mounting surface, and the end portion of the lead-out part of the coil being disposed inside the molded body; and
a conductor, at least partially buried in the molded body, and connecting the external electrode and the lead-out part.

2. The surface-mount inductor according to claim 1, wherein the conductor is entirely buried in the molded body.

3. The surface-mount inductor according to claim 1, wherein the conductor has a surface partially exposed from the molded body.

4. The surface-mount inductor according to claim 1, wherein the lead-out part has a connecting portion thinner than the conductive wire, and the connecting portion is connected to the conductor.

5. The surface-mount inductor according to claim 2, wherein the lead-out part has a connecting portion thinner than the conductive wire, and the connecting portion is connected to the conductor.

6. The surface-mount inductor according to claim 3, wherein the lead-out part has a connecting portion thinner than the conductive wire, and the connecting portion is connected to the conductor.

7. The surface-mount inductor according to claim 1, wherein a winding axis of the coil is orthogonal to the mounting surface.

8. The surface-mount inductor according to claim 2, wherein a winding axis of the coil is orthogonal to the mounting surface.

9. The surface-mount inductor according to claim 3, wherein a winding axis of the coil is orthogonal to the mounting surface.

10. The surface-mount inductor according to claim 4, wherein a winding axis of the coil is orthogonal to the mounting surface.

11. The surface-mount inductor according to claim 5, wherein a winding axis of the coil is orthogonal to the mounting surface.

12. The surface-mount inductor according to claim 6, wherein a winding axis of the coil is orthogonal to the mounting surface.

13. The surface-mount inductor according to claim 1, wherein the molded body defines a hole therein, and at least a portion of the conductor is disposed in the hole.

14. The surface-mount inductor according to claim 13, wherein the hole extends orthogonal to the mounting surface.

15. The surface-mount inductor according to claim 13, wherein the hole traverses the lead-out part.

16. The surface-mount inductor according to claim 13, wherein the hole extends from the mounting surface to a hole end inside the molded body, and the lead-out part is exposed to the hole at a location between the mounting surface and the hole end.

17. The surface-mount inductor according to claim 13, wherein the hole extends from the mounting surface to a hole end inside the molded body, and the lead-out part is exposed to the hole at the hole end.

18. The surface-mount inductor according to claim 1, wherein the molded body defines a groove therein extending along the mounting surface, and at least a portion of the conductor is disposed in the groove.

19. The surface-mount inductor according to claim 18, wherein the lead-out part is exposed to the groove.

20. The surface-mount inductor according to claim 1, wherein the conductor is disposed directly under the external electrode.
